(19) United States
(12) Patent Application Publication
(10) Pub. No.: US 2023/0185956 A1
(43) Pub. Date: Jun. 15, 2023

(54) CONCEALMENT APPARATUS, CONCEALMENT METHOD, AND RECORDING MEDIUM

(71) Applicant: Hitachi, Ltd., Tokyo (JP)

(72) Inventor: Kensuke KOBAYASHI, Tokyo (JP)

(21) Appl. No.: 17/879,855

(22) Filed: Aug. 3, 2022

(30) Foreign Application Priority Data
Dec. 13, 2021 (JP) 2021-201784

(51) Int. Cl. G06F 21/62; G06F 16/23

(52) U.S. Cl. CPC G06F 21/6245; G06F 16/2358; G06F 16/2365

(57) ABSTRACT

A concealment apparatus includes: a processor configured to execute a program; and a storage device configured to store the program, the processor being configured to execute: concealment processing for controlling, in regard to a resource having one or more items and data indicating details of the one or more items, concealment of the data based on an attribute of a user and attributes of the one or more items for each user; and first output processing for outputting the resource which is based on a concealment result of executing the concealment processing for each user, to a terminal corresponding to the each user.

### CLAIM OF PRIORITY

The present application claims priority from Japanese patent application JP 2021-201784 filed on Dec. 13, 2021, the content of which is hereby incorporated by reference into this application.

### BACKGROUND OF THE INVENTION

This invention relates to a concealment apparatus and a concealment method which conceal data, and a recording medium.

Due to General Data Protection Regulation (GDPR) and other restrictions having the purpose of protection of data such as personal information, information required to be concealed varies depending on a viewing user on a management user interface (UI) of a storage apparatus or another UI having the purpose of displaying and managing resources including customer information. Methods adopted in a case in which certain information including customer information is disclosed to a user from whom the customer information is required to be concealed include a method of collecting screenshots and then manually hiding the customer information to provide the certain information and a method of constructing a simulated environment that does not include the customer information and then allowing the user to access the simulated environment. JP 2004-178498 A is disclosed as a publicly known technology for masking confidential information by static display control in such a manner.

JP 2004-178498 A discloses a browsable information management system that can control a hidden area of a confidential position flexibly in dependence on a user's browsing authority level about browsable information including character strings, images, video or the like, without requiring a burden in maintenance for accommodation for a new user or the like.

The browsable information management system has a mask layer data selecting means and a mask layer data synthesizing means. The selecting means select a single piece of or a plurality of mask layer data depending on a user's browsing authority level from a plurality of mask layer data 2 to 5 with hiding areas 6 to 10 painted. The synthesizing means synthesize the single piece of or the plurality of mask layer data selected by the selecting means with original data 1 as browsable information. The browsable information is subjected to hiding processing before provided for the user.

However, users having different levels of data protection cannot share a production environment with each other, and hence it is difficult to work simultaneously in real time. In addition, corporations are not allowed to directly share the same environment for collaboration and problem solving therebetween, and hence a large amount of time and cost is required.

### SUMMARY OF THE INVENTION

This invention has an object to improve convenience of simultaneous viewing between users having different levels of data protection.

An aspect of the disclosure in the present application is a concealment apparatus, comprising: a processor configured to execute a program; and a storage device configured to store the program, the processor being configured to execute: concealment processing for controlling, in regard to a resource having one or more items and data indicating details of the one or more items, concealment of the data based on an attribute of a user and attributes of the one or more items for each user; and first output processing for outputting the resource which is based on a concealment result of executing the concealment processing for each user, to a terminal corresponding to the each user.

According to the representative embodiment of this invention, it is possible to improve the convenience of simultaneous viewing between users having different levels of data protection. Other objects, configurations, and effects than those described above are clarified by the following description of an embodiment.

### BRIEF DESCRIPTION OF THE DRAWINGS

FIG. 1 is a block diagram for illustrating a hardware configuration example of a concealment system.

FIG. 2 is an explanatory diagram for illustrating an example of referring to data in the concealment system.

FIG. 3 is an explanatory diagram for illustrating a data update example 1 in the concealment system.

FIG. 4 is an explanatory diagram for illustrating a data update example 2 in the concealment system.

FIG. 5 is an explanatory table for showing an example of the session table.

FIG. 6 is an explanatory table for showing an example of the resource type table.

FIG. 7 is an explanatory table for showing an example of the resource table.

FIG. 8 is an explanatory table for showing an example of the mapping table.

FIG. 9 is an explanatory table for showing an example of a concealment determination pattern.

FIG. 10 is an explanatory table for showing an example of concealment determination processing based on the concealment determination pattern shown in FIG. 9.

FIG. 11 is a flow chart for illustrating an example of child session generation processing executed by the concealment apparatus.

FIG. 12 is a flow chart for illustrating an example of the dummy generation processing illustrated in FIG. 11 (Step S1105).

FIG. 13 is a flow chart for illustrating an example of the screen display processing.

FIG. 14 is a flow chart for illustrating an example of the data update processing.

FIG. 15 is a flow chart for illustrating an example of the session discard processing.

FIG. 16 is a flow chart for illustrating an example of the dummy discard processing (each of Step S1504 and Step S1508) illustrated in FIG. 15.

### DETAILED DESCRIPTION OF THE PREFERRED EMBODIMENTS

Now, a concealment apparatus according to at least one embodiment of this invention is described. In the following description, “concealment” includes rewriting values of some or all of items of information being resources into insignificant graphic forms (for example, solid black portion), which are different from characters, while maintaining attributes of those items, and also rewriting those items into other significant data while maintaining the attributes of those items. In other words, data is displayed as fictitious data for a user against whom the data is to be protected. In addition, the “resource” is information, for example, customer information, that can be referred to from the concealment apparatus by a terminal for business capable of communicating to/from the concealment apparatus.

<Hardware Configuration Example of Concealment System>

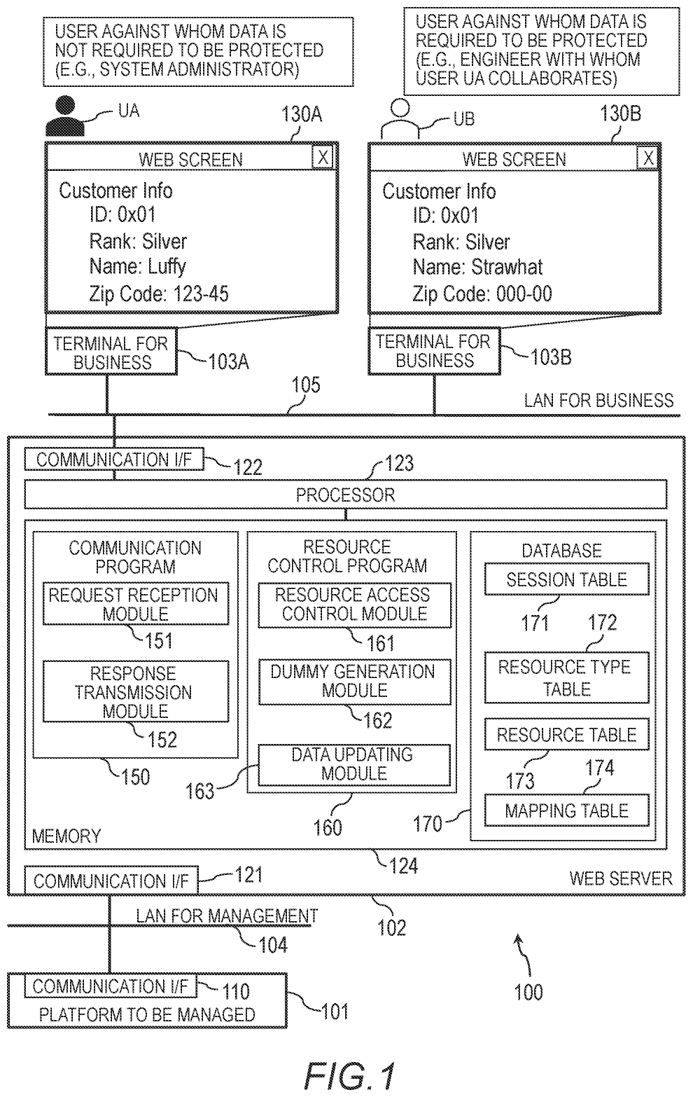

FIG. 1 is a block diagram for illustrating a hardware configuration example of a concealment system. A concealment system 100 includes a platform 101 to be managed, a concealment apparatus 102, and a plurality of (in FIG. 1, for example, two) terminals 103A and 103B for business (the terminals 103A and 103B for business are referred to simply as “terminal 103 for business” unless specifically distinguished from each other).

The platform 101 to be managed and the concealment apparatus 102 are coupled to each other so as to enable communication therebetween through, for example, a local area network (LAN) 104 for management. The concealment apparatus 102 and the terminal 103 for business are coupled to each other so as to enable communication therebetween through, for example, a LAN 105 for business. Each of the LAN 104 for management and the LAN 105 for business may be the Internet or a wide area network (WAN).

The platform 101 to be managed is a platform to be managed by the concealment apparatus 102. The platform 101 to be managed includes a communication interface 110. The communication interface 110 is coupled to a communication interface 121 of the concealment apparatus 102 so as to enable communication therebetween through the LAN 104 for management.

The concealment apparatus 102 functions as a Web server for the terminal 103 for business. Specifically, for example, the concealment apparatus 102 includes the communication interface 121, a communication interface 122, a processor 123, and a memory 124. The communication interface 121 is coupled to the communication interface 110 of the platform 101 to be managed so as to enable communication therebetween through the LAN 104 for management. The communication interface 122 is coupled to the terminal 103 for business so as to enable communication therebetween through the LAN 105 for business.

The processor 123 controls the concealment apparatus 102. The memory 124 serves as a work area for the processor 123. The memory 124 is also a non-transitory or transitory recording medium for storing various programs and data. The memory 124 is formed of a storage device, for example, a read only memory (ROM), a random access memory (RAM), a hard disk drive (HDD), and a flash memory.

The memory 124 stores a communication program 150, a resource control program 160, and a database 170. The database 170 may be stored in a database server (not shown) coupled to the LAN 104 for management or the LAN 105 for business.

In the communication program 150, a request reception module 151 and a response transmission module 152 are specifically functions implemented by, for example, causing the processor 123 to execute the communication program 150.

The request reception module 151 receives a request from the terminal 103 for business. The response transmission module 152 transmits a response to the terminal 103 for business from which the request has been transmitted.

In the resource control program 160, a resource access control module 161, a dummy generation module 162, and a data updating module 163 are specifically functions implemented by, for example, causing the processor 123 to execute the resource control program 160.

The resource access control module 161 controls access to resources. The resource refers to each entry of a resource table 173. The dummy generation module 162 generates dummy data obtained by concealing data required to be concealed in a data group included in the resource. The data updating module 163 updates data changed by the terminal 103 for business in the data group of the resource.

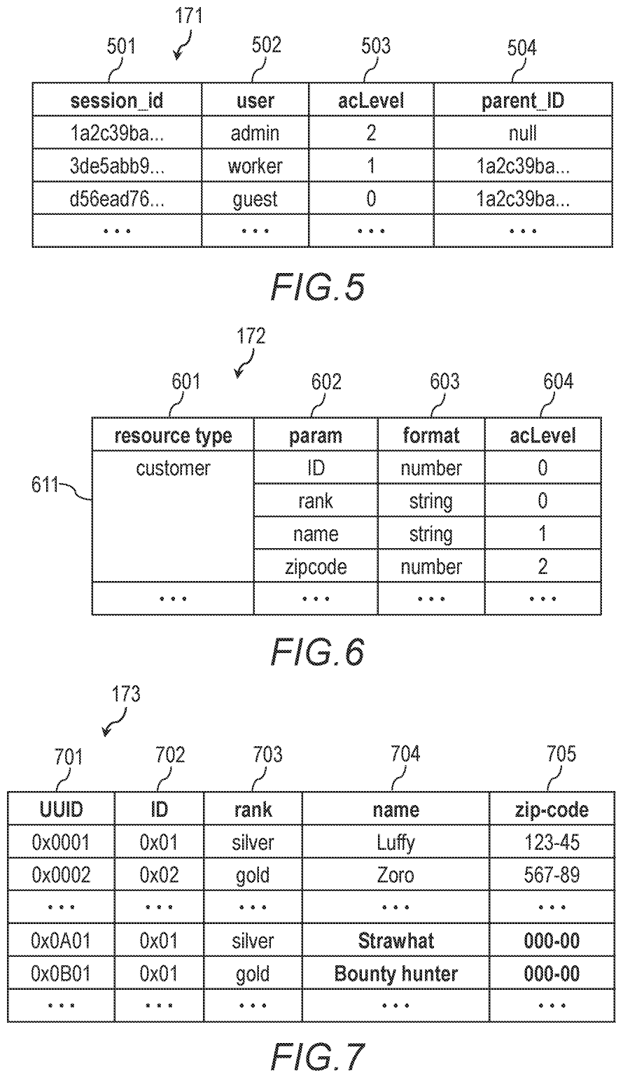

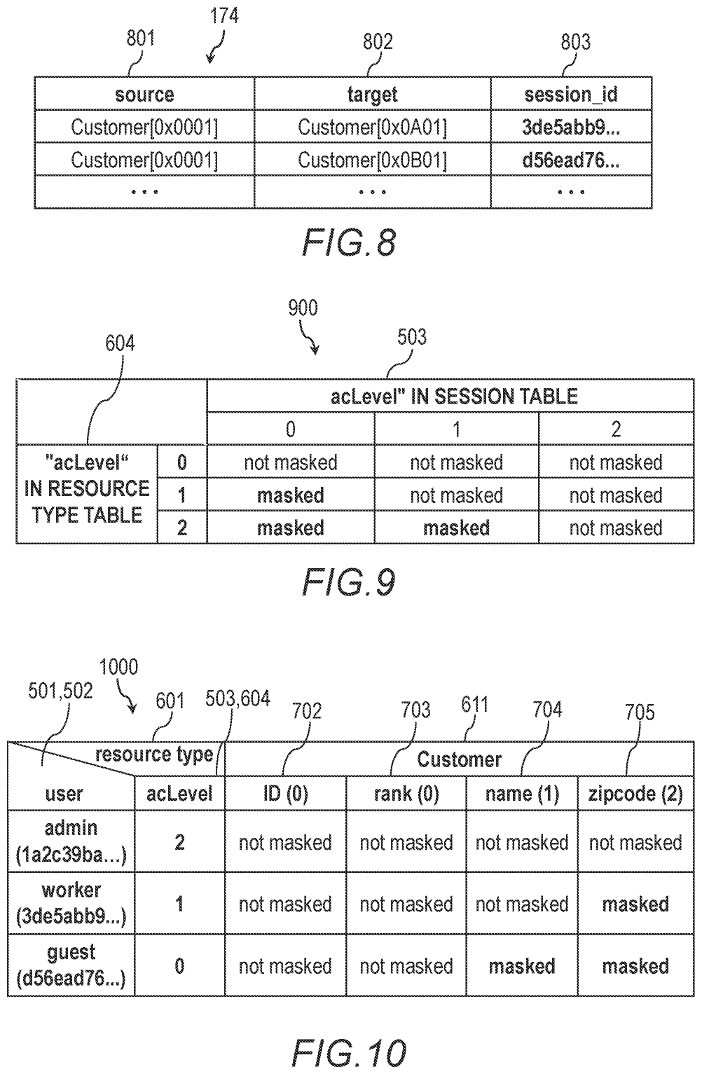

The database 170 includes a session table 171, which is described later with reference to FIG. 5, a resource type table 172, which is described later with reference to FIG. 6, the resource table 173, which is described later with reference to FIG. 7, and a mapping table 174, which is described later with reference to FIG. 8.

Although not shown, the concealment apparatus 102 may include input devices, for example, a keyboard, a mouse, a touch panel, a numeric keypad, a scanner, a microphone, and a sensor, and output devices, for example, a display, a printer, and a speaker.

The terminal 103A for business is a computer to be used by a user UA against whom data is not required to be protected. The user UA is, for example, a system administrator (“admin”) of the concealment system 100. The terminal 103A for business displays a Web screen 130A based on the response from the concealment apparatus 102.

On the Web screen 130A, an ID (“ID”) of “0x01,” a rank (“Rank”) of “Silver,” a name (“Name”) of “Luffy,” and a zip code (“Zip Code”) of “123-45” are displayed as customer information (“Customer Info”) handled by a business operator to which the user UA belongs.

The ID is identification information that uniquely identifies a customer, and “0x01” indicates the ID of the customer having the name of “Luffy.” The rank is a grade of the customer, and “Silver” indicates the grade of the customer having the name of “Luffy.” The name is a character string indicating a name (for example, full name or handle) that designates the customer, and “Luffy” is the name of the customer having the ID of “0x01.” The zip code is a number string that classifies each of areas including a place of residence of the customer for the purpose of delivery of mail, and “123-45” is the zip code of the customer having the name of “Luffy.” The user UA is a person against whom data is not required to be protected, and hence the customer information is displayed on the Web screen 130A without being concealed.

The terminal 103B for business is a computer to be used by a user UB against whom data is required to be protected. The user UB is, for example, an engineer with whom the user UA collaborates, and is in the position of “guest” from the viewpoint of the user UA. The terminal 103B for business displays a Web screen 130B. On the Web screen 130B, the ID of “0x01,” the rank of “Silver,” a name of “Strawhat,” and a zip code of “000-00” are displayed as customer information handled by the business operator to which the user UA belongs.

The user UB is a person against whom data is required to be protected, and hence the name and the zip code, which are parts of the customer information, are displayed on the Web screen 130B simultaneously with the display on the Web screen 130A with the name changed for concealment from “Luffy” to “Strawhat” and the zip code changed for concealment from “123-45” to “000-00.” In the following description, the Web screens 130A and 130B are referred to simply as “Web screen 130” unless specifically distinguished from each other.

<Example of referring to Data>

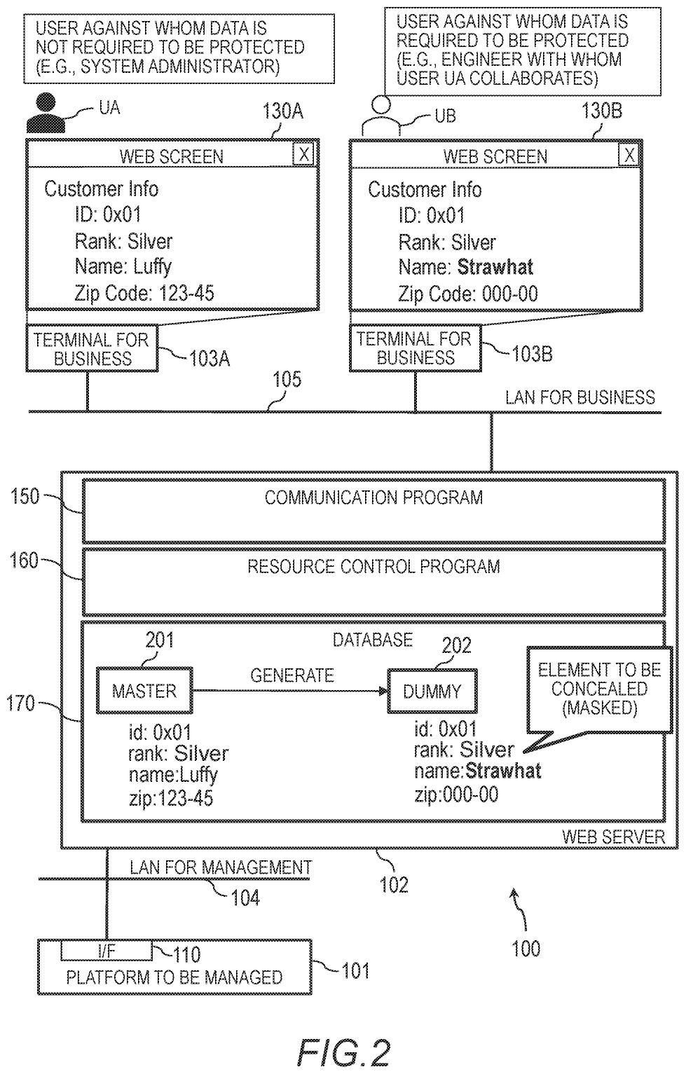

FIG. 2 is an explanatory diagram for illustrating an example of referring to data in the concealment system 100. FIG. 2 is an illustration of an example in which the customer information illustrated in FIG. 1 is displayed on the Web screen 130A and the Web screen 130B and referred to by the users UA and UB, respectively. The resource to be displayed is stored in the database 170 as master data 201. The master data 201 is customer information having the ID of “0x01,” the rank of “Silver,” the name of “Luffy,” and the zip code of “123-45,” and is registered in the resource table 173 as an entry thereof.

The dummy generation module 162 generates dummy data 202 from the master data 201. The dummy data 202 is customer information having: the ID of “0x01” and the rank of “Silver,” which are included in the master data 201; and the name of “Strawhat” and the zip code of “000-00,” which are changed for concealment from the name of “Luffy” and the zip code of “123-45,” which are included in the master data 201, respectively. The dummy data 202 is also registered in the resource table 173 as an entry thereof separately from the master data 201.

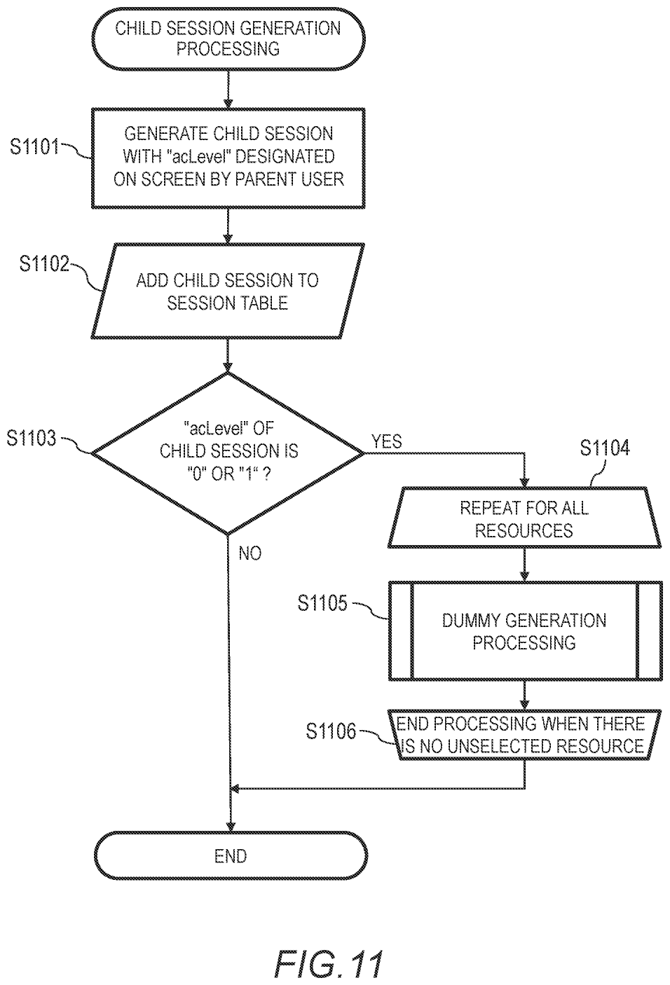

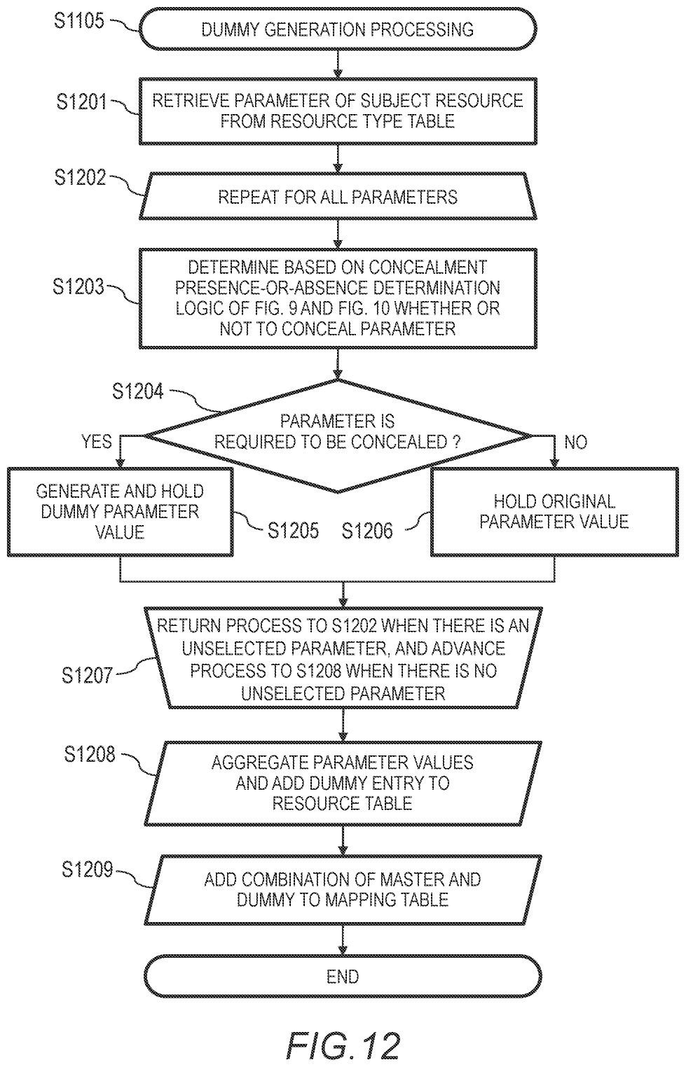

Which data included in the master data 201 is to be concealed is determined based on the attributes of the data and the attributes of the user UB as described later with reference to FIG. 9 and FIG. 10. The concealment apparatus 102 transmits the master data 201 to the terminal 103A for business, and transmits the dummy data 202 to the terminal 103B for business. Thus, the master data 201 is displayed on the Web screen 130A of the terminal 103A for business, and the dummy data 202 is displayed on the Web screen 130B of the terminal 103B for business simultaneously with the display on the Web screen 130A.

In an exemplary case in which the users UA and UB refer to the customer information at a Web conference participated by the users UA and UB, even when there is data (name of “Luffy” and zip code of “123-45” of the customer) that the user UA does not wish to show to the user UB, the name of “Luffy” and the zip code of “123-45” of the customer have been converted for concealment into “Strawhat” and “000-00,” respectively, at the time of being referred to by the user UB.

This eliminates time and labor for the user UA to correct the items of the name of “Luffy” and the zip code of “123-45” of the customer on the Web server and to have the corrected items transmitted from the Web server to the terminal 103B for business of the user UB. Therefore, congestion of traffic in the LAN 105 for business is reduced, and a load on the concealment apparatus 102 can be reduced.

Further, the time and labor for the above-mentioned correction are not required, and hence even the users UA and UB who have different data protection levels can refer to the same customer information in real time. Therefore, convenience of the users UA and UB is high, and efficiency of progress of the conference can be improved.

<Data Update Example>

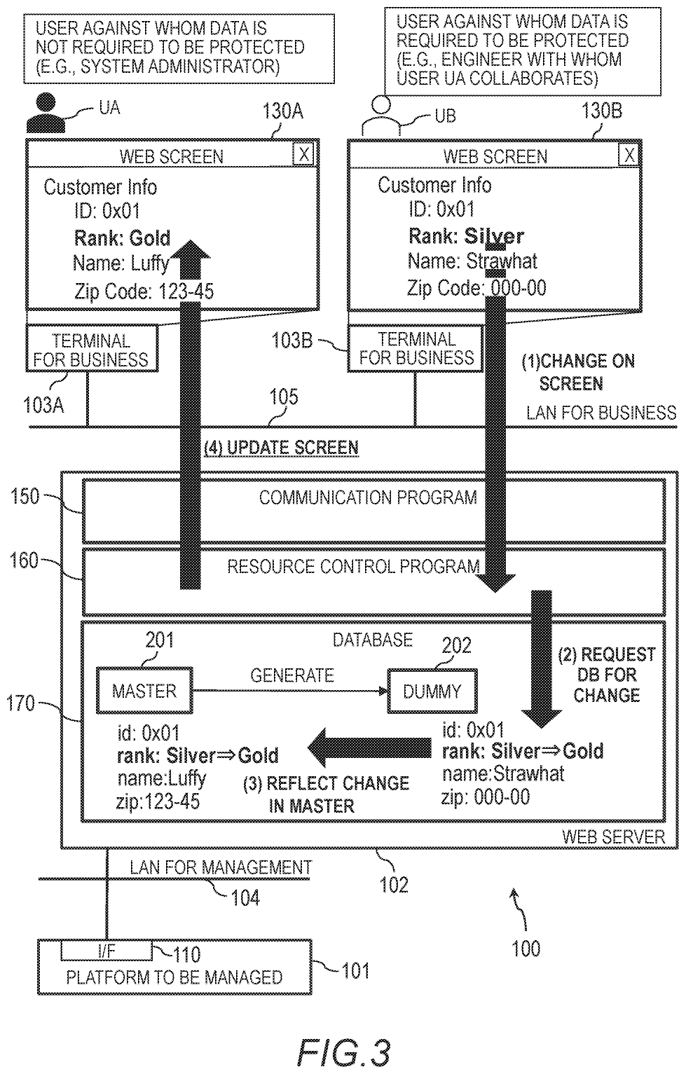

FIG. 3 is an explanatory diagram for illustrating a data update example 1 in the concealment system 100. The data update example 1 indicates an example of updating the master data 201 when the dummy data 202 has been updated on the terminal 103B for business.

(1) When the rank is changed from “Silver” to “Gold” on the terminal 103B for business by an operation of the user UB, the terminal 103B for business transmits a change request for the rank to the concealment apparatus 102. The rank is data that can be changed by the user UB.

(2) When the change request for the rank from “Silver” to “Gold,” which is described in the item (1), is received by the request reception module 151, the concealment apparatus 102 causes the data updating module 163 to change the rank of the dummy data 202 stored in the resource table 173 from “Silver” to “Gold.”

(3) The concealment apparatus 102 causes the data updating module 163 to reflect the change of the rank from “Silver” to “Gold” in the dummy data 202, which is described in the item (2), in the master data 201 stored in the resource table 173.

(4) The concealment apparatus 102 causes the response transmission module 152 to transmit, to the terminal 103A for business, the master data 201 in which the change of the rank from “Silver” to “Gold” has been reflected as described in the item (3), to thereby update the Web screen 130A. Thus, the change on the terminal 103B for business is immediately reflected on the Web screen 130A.

In this manner, for data that is not concealed for both the users UA and UB, a change performed by any one of the users UA and UB is immediately reflected in the other.

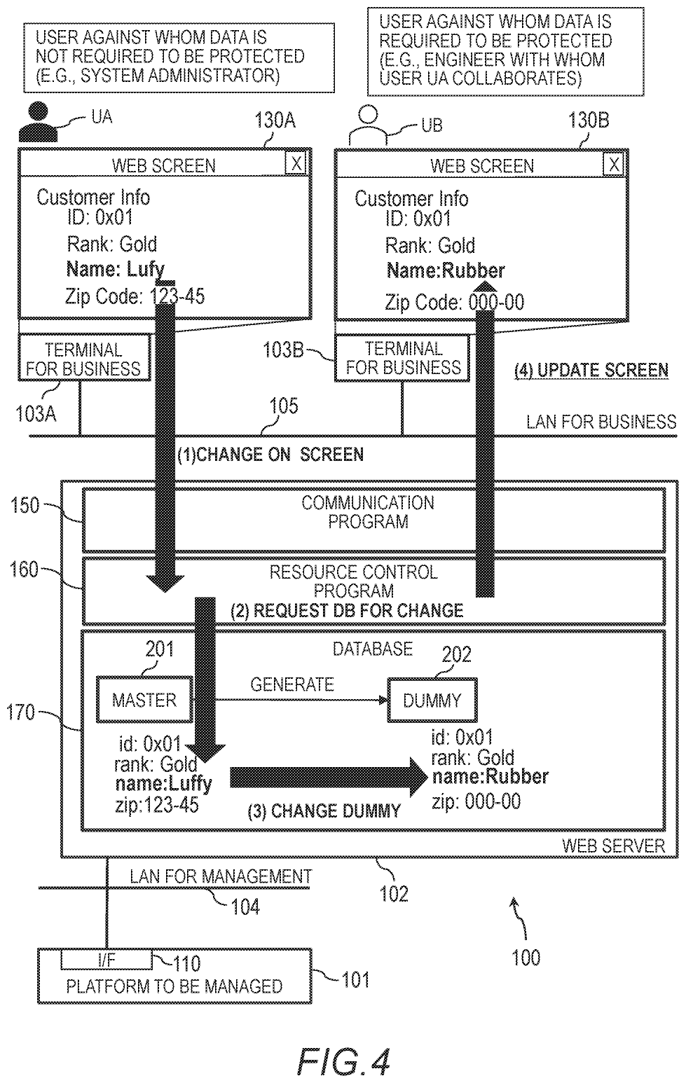

FIG. 4 is an explanatory diagram for illustrating a data update example 2 in the concealment system 100. The data update example 2 indicates an example of updating the dummy data 202 when the master data 201 has been updated on the terminal 103A for business. In FIG. 4, a case in which the name of the master data 201 has an error and the error is corrected is given as an example. The user UA has the authority to change the name, while the user UB does not.

(1) When the name is changed from “Lufy” to “Luffy” on the terminal 103A for business by an operation of the user UA, the terminal 103A for business transmits a change request for the name to the concealment apparatus 102.

(2) When the change request for the name from “Lufy” to “Luffy,” which is described in the item (1), is received by the request reception module 151, the concealment apparatus 102 causes the data updating module 163 to change the name of the master data 201 stored in the resource table 173 from “Lufy” to “Luffy.”

(3) As triggered by the change of the name from “Lufy” to “Luffy” of the master data 201, which is described in the item (2), the concealment apparatus 102 causes the dummy generation module 162 to generate a name of “Rubber” as a dummy name corresponding to “Luffy” obtained after the change. The generation of a dummy name is an existing technology, and hence details thereof are omitted. The dummy name may be a character string converted from the character string of the input data (in this case, “Luffy”), or may be an irrelevant randomized character string. In another case, a character string relating to the input data may be acquired from the platform 101 to be managed or a website on the Internet. Then, the concealment apparatus 102 changes the name of “Strawhat” of the dummy data 202 stored in the resource table 173 to the dummy name of “Rubber.”

(4) The concealment apparatus 102 causes the response transmission module 152 to update the Web screen 130B of the terminal 103B for business by the dummy data 202 in which the dummy name “Rubber” has been reflected as described in the item (3). Thus, the change on the terminal 103A for business is immediately reflected on the Web screen 130B. In this manner, when the user UA changes the data concealed from the user UB, the change is immediately reflected on the terminal 103B for business of the user UB.

In the item (3), the dummy generation module 162 is not required to generate a dummy name. In this case, the name of the dummy data 202 remains “Strawhat,” and the Web screen 130B is not updated as well. Thus, the fact that the name has been corrected on the terminal 103A for business per se is concealed.

<Database 170>

Next, a group of tables stored in the database 170 are specifically described.

FIG. 5 is an explanatory table for showing an example of the session table 171. The session table 171 is a table for managing a session established between the concealment apparatus 102 and the terminal 103 for business. The session table 171 includes, as fields thereof, a session ID (“session_id”) 501, a user name (“user”) 502, a first concealment control level (“acLevel”) 503, and a parent session ID (“parent_ID”) 504. A combination of values of the fields 501 to 504 in the same row forms an entry that defines one session.

The session ID 501 is identification information that uniquely identifies a session. The user name 502 is a character string indicating a name (for example, full name, handle, job title, or occupational category name) that designates a user using the terminal 103 for business for which the session has been established, and indicates an attribute of the user. A value of “admin” indicates a manager for a certain business operator, a value of “worker” indicates an employee for the business operator, and a value of “guest” indicates an employee (participant) with whom the business operator collaborates.

The first concealment control level 503 is a level for controlling whether or not to execute concealment of data from the user identified by the user name 502. In other words, the first concealment control level 503 indicates how less data is required to be protected against the user. As the level has a larger value, the concealment of the data is less likely to be executed (the data is less required to be protected), and as the level has a smaller value, the concealment of the data is more likely to be executed (the data is more required to be protected).

In this example, for example, the user name 502 corresponding to the first concealment control level 503 having a value of “2” is a user attribute that does not require the protection (concealment) of the data, and the user name 502 corresponding to the first concealment control level 503 having a value of “0” is a user attribute that requires the protection (concealment) of the data. The user name 502 corresponding to the first concealment control level 503 having a value of “1” is a user attribute for which it is to be determined whether or not the data is required to be protected (concealed) based on a second concealment control level 604, which is described later.

A combination of the user name 502 and the first concealment control level 503 is managed in the memory 124 by a table (not shown), and is referred to when an entry of the session table 171 is generated.

The parent session ID 504 is identification information that uniquely identifies a parent session. When the session defined by the session ID 501 is a child session, the parent session is a session being a generation source of the child session. In other words, the parent session ID 504 is the session ID 501 of the session being the generation source. For the parent session, no parent session is present, and hence the parent session ID 504 in an entry that defines a parent session has a value of “null” indicating that, for the parent session, no parent session is present.

In addition, the user UA of the terminal 103A for business for which a parent session has been established with respect to the concealment apparatus 102 may be referred to as “parent user,” and the user UB of the terminal 103B for business for which a child session has been established with respect to the concealment apparatus 102 may be referred to as “child user.”

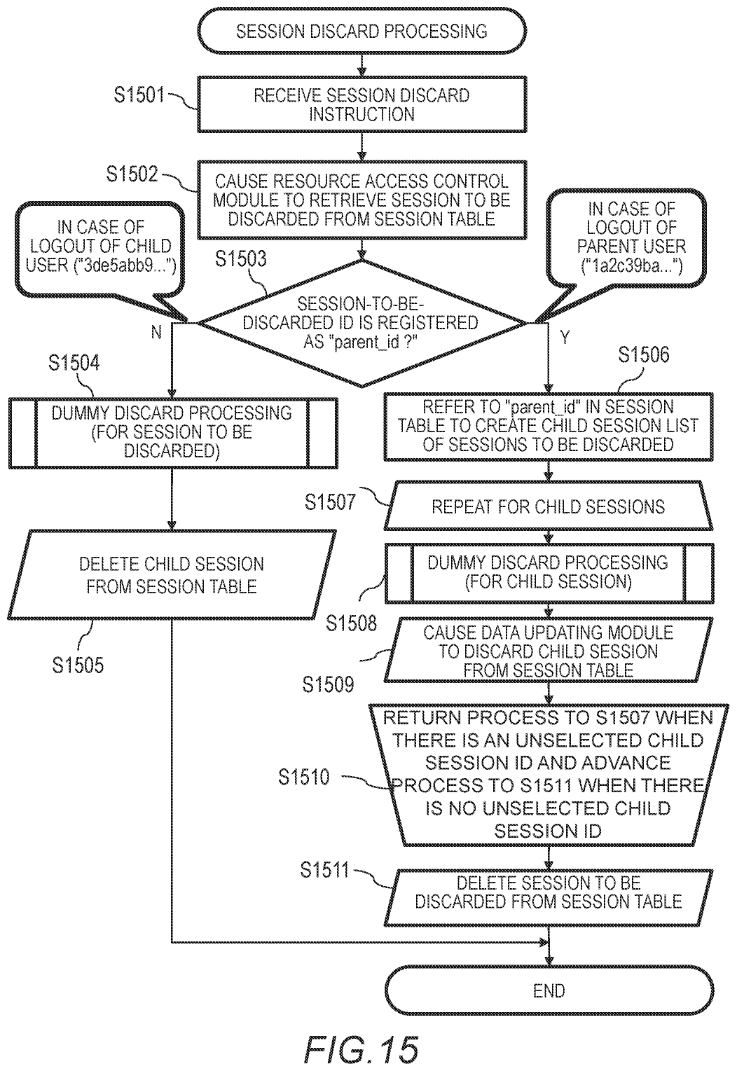

In FIG. 5, an entry in the first row indicates a parent session due to the absence of the parent session ID 504, and entries in the second row and the third row have the same value of the parent session ID 504 as the value of the session ID 501 in the entry in the first row, and thus indicate child sessions of the parent session. When the session is ended by the concealment apparatus 102 or the terminal 103 for business, the resource access control module 161 deletes the entry for the session from the session table 171 as described later with reference to FIG. 15.

FIG. 6 is an explanatory table for showing an example of the resource type table 172. The resource type table 172 is a table that defines attributes of data in the resource. The resource is customer information or other information that can be referred to by a plurality of terminals 103 for business.

The resource type table 172 includes, as fields thereof, a resource type (“resource type”) 601, a parameter (“param”) 602, a format (“format”) 603, and the second concealment control level (“acLevel”) 604. A combination of values of the fields 601 to 604 in each row of the resource type 601 forms an entry that defines one resource type 601.

The resource type 601 is a type of resource such as a customer (“customer”) 611. The parameter 602 is an item provided for each resource type 601, and indicates an attribute of data in the resource. The parameter 602 is, for example, the ID (“ID”), the rank (“rank”), the name (“name”), and the zip code (“zip code”), which are illustrated on the Web screen 130 of each of FIG. 1 to FIG. 4, when the value of the resource type 601 is the customer 611.

The format 603 is a description format of the parameter 602. For example, a value of “number” indicates a description format in which the parameter 602 is represented by a numerical value, and a value of “string” indicates a description format in which the parameter 602 is represented by a character string.

The second concealment control level 604 is a level for controlling whether or not to execute concealment of the data for the resource identified by the resource type 601. As the level has a larger value, the concealment of the data is more likely to be executed, and as the level has a smaller value, the concealment of the data is less likely to be executed.

In FIG. 6, an entry having the value of the resource type 601 being the customer 611 has four parameters 602 of the ID (“ID”), the rank (“rank”), the name (“name”), and the zip code (“zip code”), and has values of the second concealment control level 604 being “0”, “0”, “1”, and “2”, respectively. In other words, the ID (“ID”) and the rank (“rank”) are less likely to be concealed than the name (“name”), and the zip code (“zip code”) is more likely to be concealed than the name (“name”).

In this example, for example, the parameter 602 corresponding to the second concealment control level 604 having a value of “0” is an item attribute that does not require the protection (concealment) of the data, and the parameter 602 corresponding to the second concealment control level 604 having a value of “2” is an item attribute that requires the protection (concealment) of the data. The parameter 602 corresponding to the second concealment control level 604 having a value of “1” is an item attribute for which it is to be determined whether or not the data is required to be protected (concealed) based on the first concealment control level 503.

FIG. 7 is an explanatory table for showing an example of the resource table 173. The resource table 173 is a table for storing data relating to a resource. The resource table 173 is provided for each resource type 601. In FIG. 7, the resource table 173 to be used when the value of the resource type 601 is the customer 611 is described as an example.

The resource table 173 includes, as fields thereof: a universally unique identifier (“UUID”) 701; and an ID (“ID”) 702, a rank (“rank”) 703, a name (“name”) 704, and a zip code (“zip code”) 705, which are the parameters 602 with the value of the resource type 601 being the customer 611. Values of the ID 702, the rank 703, the name 704, and the zip code 705 indicate details of the parameters 602.

A combination of values of the fields 701 to 705 in the same row forms an entry that defines customer information being one resource. However, in order to distinguish between the master data 201 and the dummy data 202 on the same customer, an entry of the master data 201 and an entry of the dummy data 202 are stored separately from each other even for the same customer.

The UUID 701 is identification information that uniquely identifies customer information being a resource. The ID 702 is identification information that uniquely identifies the customer 611 in the customer information identified by the UUID 701, and is displayed as “ID” on the Web screen 130. As described above, the entry of the master data 201 and the entry of the dummy data 202 are stored separately from each other even for the same customer 611, and hence the ID 702 may have the same value in a plurality of entries.

The rank 703 is a grade of the customer 611 identified by the ID 702, and is displayed as “Rank” on the Web screen 130. The name 704 is a character string indicating a name (for example, full name or handle) that designates the customer 611 identified by the ID 702, and is displayed as “Name” on the Web screen 130. When the entry is of the dummy data 202, a dummy name is registered as a value of the name 704. The zip code 705 is a number string that classifies an area including the place of residence of the customer 611 identified by the ID 702 for the purpose of delivery of mail, and is displayed as “Zip Code” on the Web screen 130.

FIG. 8 is an explanatory table for showing an example of the mapping table 174. The mapping table 174 is a table for storing relevance between the master data 201 and the dummy data 202. The mapping table 174 includes, as fields thereof, a source (“source”) 801, a target (“target”) 802, and a relevant session ID (“session_id”) 803. A combination of values of the fields 801 to 803 in the same row forms an entry that defines the relevance between one piece of master data 201 and one piece of dummy data 202.

The source 801 is a combination of the values of the resource type 601 and the UUID 701 of the master data 201, and uniquely identifies the master data 201. The target 802 is a combination of the values of the resource type 601 and the UUID 701 of the dummy data 202, and uniquely identifies the dummy data 202.

The relevant session ID 803 is the session ID 501 relating to the source 801 and the target 802. Specifically, for example, the relevant session ID 803 is the session ID 501 of a child session generated for the terminal 1038 for business provided with the dummy data 202 identified by the target 802, in response to designation from the terminal 103A for business provided with the master data 201 identified by the source 801.

When the session is ended by the concealment apparatus 102 or the terminal 103 for business, the resource access control module 161 deletes, from the mapping table 174, the entry in which the session ID 501 of the session is registered as the relevant session ID 803.

<Example of Concealment Determination Processing>

FIG. 9 is an explanatory table for showing an example of a concealment determination pattern. In FIG. 9, a concealment determination pattern 900 indicates: a combination of the value of the first concealment control level 503 and the value of the second concealment control level 604; and whether or not to conceal data for each combination. The concealment apparatus 102 refers to the concealment determination pattern 900 to determine whether the value of each of the parameters 602 (ID 702, rank 703, name 704, and zip code 705) to be subjected to concealment determination is data that is to be concealed (“masked”) or data that is not to be concealed (“not masked”).

FIG. 10 is an explanatory table for showing an example of concealment determination processing based on the concealment determination pattern 900 shown in FIG. 9. In a concealment determination processing table 1000, the leftmost column indicates the session ID 501 and the user name 502, and the uppermost row indicates the resource type 601 being the customer 611. A column of “acLevel” indicates the first concealment control level 503 for each combination of the session ID 501 and the user name 502. A row of “acLevel” indicates the second concealment control level 604 of each of the ID 702, the rank 703, the name 704, and the zip code 705.

In FIG. 10, each cell is identified by: a row identified by the combination of the session ID 501 and user name 502 and the first concealment control level 503; and a column identified by the second concealment control level 604 of each of the ID 702, the rank 703, the name 704, and the zip code 705. In each cell, a value of “masked” (concealed) or “not masked” (not concealed) is stored as a result of the concealment determination. The concealment apparatus 102 refers to the result of the concealment determination to conceal or not conceal the values of the ID 702, the rank 703, the name 704, and the zip code 705 in the session for the user identified by the session ID 501 and the user name 502.

For example, for a session (session ID 501 of “1a2c39ba . . . ”) for the user UA having the user name 502 of “admin,” the first concealment control level 503 has the value of “2”. Accordingly, no matter which values the second concealment control level 604 of the ID 702, the rank 703, the name 704, and the zip code 705 have, pieces of data on the resource, which are the values of the ID 702, the rank 703, the name 704, and the zip code 705, are not concealed (“not masked”) on the Web screen 130A of the terminal 103A for business of the user UA (see the column in which the first concealment control level 503 of FIG. 9 has the value of “2”).

Meanwhile, for a session (session ID 501 of “3de5abb9 . . . ”) for the user having the user name 502 of “worker,” the first concealment control level 503 has the value of “1”. Accordingly, when the user is the user UB, pieces of data on the resource, which are the values of the ID 702, the rank 703, and the name 704 with the second concealment control level 604 having the value of “1” or less among the ID 702, the rank 703, the name 704, and the zip code 705, are not concealed (“not masked”) on the Web screen 130B of the terminal 103 for business of the user UB, and a piece of data on the resource, which is the value of the zip code 705 with the second concealment control level 604 having the value of “2”, is concealed (“masked”) on the Web screen 130B (see the column in which the first concealment control level 503 of FIG. 9 has the value of “1”).

Meanwhile, for a session (session ID 501 of “d56ead76 . . . ”) for the user UB having the user name 502 of “guest,” the first concealment control level 503 has the value of “0”. Accordingly, when the user is the user UB, pieces of data on the resource, which are the values of the ID 702 and the rank 703 with the second concealment control level 604 having the value of “0” among the ID 702, the rank 703, the name 704, and the zip code 705, are not concealed (“not masked”) on the Web screen 130B of the terminal 103 for business of the user UB, and pieces of data on the resource, which are the values of the name 704 and the zip code 705 with the second concealment control level 604 having the value of “1” or more, are concealed (“masked”) on the Web screen 130B (see the column in which the first concealment control level 503 of FIG. 9 has the value of “0”).

The determination processing using FIG. 9 and FIG. 10 is referred to as “concealment presence-or-absence determination logic.”

<Child Session Generation Processing>

FIG. 11 is a flow chart for illustrating an example of child session generation processing executed by the concealment apparatus 102. It is assumed that, prior to the child session generation processing, a session between the concealment apparatus 102 and the terminal 103A for business of the user UA has been established as a parent session for a child session to be generated and is not interrupted. Specifically, for example, the terminal 103A for business has accessed the concealment apparatus 102 and has completed login thereto by an operation of the user UA, and the entry in the first row shown in FIG. 5 has been registered in the session table 171, but the entries in the second and subsequent rows have not been registered therein.

In addition, the terminal 103B for business of the user UB logs in to the concealment apparatus 102 in a child session to be generated, and is therefore not logged in thereto before a child session is generated. It is also assumed that the entries of the master data 201 have been registered in the resource table 173, but the entries of the dummy data 202 corresponding to the master data 201 have not been registered therein.

First, the concealment apparatus 102 causes the resource access control module 161 to generate a child session with the first concealment control level 503 of the child session designated on the Web screen 130A by the user UA being the parent user (Step S1101). For example, when the designated first concealment control level 503 of the child session is “1”, a child session between the terminal 103 for business having the user name 502 of “worker” and the concealment apparatus 102 is generated, and when the designated first concealment control level 503 of the child session is “0”, a child session between the terminal 103B for business having the user name 502 of “guest” and the concealment apparatus 102 is generated.

Subsequently, the concealment apparatus 102 causes the data updating module 163 to add an entry for the child session generated in Step S1101 to the session table 171 (Step S1102). For example, when the user UB involved in the child session is “worker,” the entry in the second row of the session table 171 is added, and when the user UB involved in the child session is “guest,” the entry in the third row of the session table 171 is added.

Subsequently, the concealment apparatus 102 determines whether or not the value of the first concealment control level 503 of the child session is “0” or “1” (Step S1103). When the value is none of “0” and “1”, that is, when the value is “2” (“No” in Step S1103), the session generated in Step S1101 is a session that is not required to be concealed, and hence the concealment apparatus 102 ends the process without generating the dummy data 202.

Subsequently, the concealment apparatus 102 selects an unselected resource from all resources (all entries of the resource table 173) (Step S1104), and causes the dummy generation module 162 to execute dummy generation processing for the selected resource (Step S1105). The dummy generation processing (Step S1105) is processing for generating the dummy data 202 for the selected resource, and details thereof are described later with reference to FIG. 12.

Subsequently, the concealment apparatus 102 determines whether or not there is an unselected resource. The concealment apparatus 102 returns the process to Step S1104 when there is an unselected resource, and ends the child session generation processing when there is no unselected resource (Step S1106).

In the example of FIG. 11, when a child session is generated, the dummy data 202 is generated by the dummy generation processing (Step S1105). However, for example, when the concealment apparatus 102 is to display the dummy data 202 on the Web screen 130B after the child session is generated, the concealment apparatus 102 may generate the dummy data 202 prior to the display.

<Dummy Generation Processing (Step S1105)>

FIG. 12 is a flow chart for illustrating an example of the dummy generation processing illustrated in FIG. 11 (Step S1105). First, the concealment apparatus 102 causes the dummy generation module 162 to retrieve the parameter 602 of the selected resource from the resource type table 172 (Step S1201). When the resource type 601 of the selected resource is the customer 611, the ID 702, the rank 703, the name 704, and the zip code 705 are retrieved as the parameters 602.

Subsequently, the concealment apparatus 102 causes the dummy generation module 162 to select an unselected parameter 602 from a group of retrieved parameters (Step S1202), and executes processing steps of from Step S1203 to Step S1206 for the selected parameter 602. Then, the concealment apparatus 102 causes the dummy generation module 162 to determine whether or not there is an unselected parameter 602. The concealment apparatus 102 returns the process to Step S1202 when there is an unselected parameter 602, and advances the process to Step S1208 when there is no unselected parameter 602 (Step S1207).

In Step S1203, the concealment apparatus 102 causes the dummy generation module 162 to determine based on the concealment presence-or-absence determination logic shown in FIG. 9 and FIG. 10 whether or not to conceal the value of each of the selected parameters 602 (702 to 705) in the selected resource (Step S1203). For example, the concealment apparatus 102 determines that data is not required to be concealed when the user UB involved in the child session is “worker” and the selected parameter 602 is any of the ID 702, the rank 703, or the name 704, and determines that data is required to be concealed when the selected parameter 602 is the zip code 705.

When the concealment apparatus 102 determines that the value of each of the selected parameters 602 (702 to 705) in the selected resource is required to be concealed (“Yes” in Step S1204), the concealment apparatus 102 causes the dummy generation module 162 to generate and hold a dummy parameter value, namely, dummy data, for each of the selected parameters 602 (702 to 705) determined to be required to be concealed, and advances the process to Step S1207.

Meanwhile, when the concealment apparatus 102 determines that the value of each of the selected parameters 602 (702 to 705) in the selected resource is not required to be concealed (“No” in Step S1204), the concealment apparatus 102 causes the dummy generation module 162 to hold the parameter value of each of the selected parameters 602 (702 to 705) determined to be not required to be concealed, and advances the process to Step S1207.

When there is no unselected parameter 602 in Step S1207, the concealment apparatus 102 causes the data updating module 163 to aggregate the values of the parameters held in Step S1205 and Step S1206 for the selected resource, and add the aggregated data as a new entry of the dummy data 202 to the resource table 173 (Step S1208).

Then, the concealment apparatus 102 causes the data updating module 163 to generate the source 801 from a combination of the values of the resource type 601 and the UUID 701 of the master data 201 and generate the target 802 from a combination of the values of the resource type 601 and the UUID 701 of the dummy data 202, and identify the relevant session ID 803 as the session ID 501 of the child session.

Then, the concealment apparatus 102 causes the data updating module 163 to register a combination of the values of the generated source 801 and target 802 and the identified relevant session ID 803 as a new entry in the mapping table 174 (Step S1209). The concealment apparatus 102 thereafter ends the dummy generation processing (Step S1105), and advances the process to Step S1106 of FIG. 11.

<Screen Display Processing>

Next, screen display processing is described. The screen display processing is output processing in which the concealment apparatus 102 outputs data on a resource to the terminal 103 for business and displays the data on the Web screen 130. Specifically, for example, in the screen display processing, the concealment apparatus 102 executes processing for displaying customer information as illustrated in FIG. 2 under a state in which the customer information is not yet displayed on the Web screen 130.

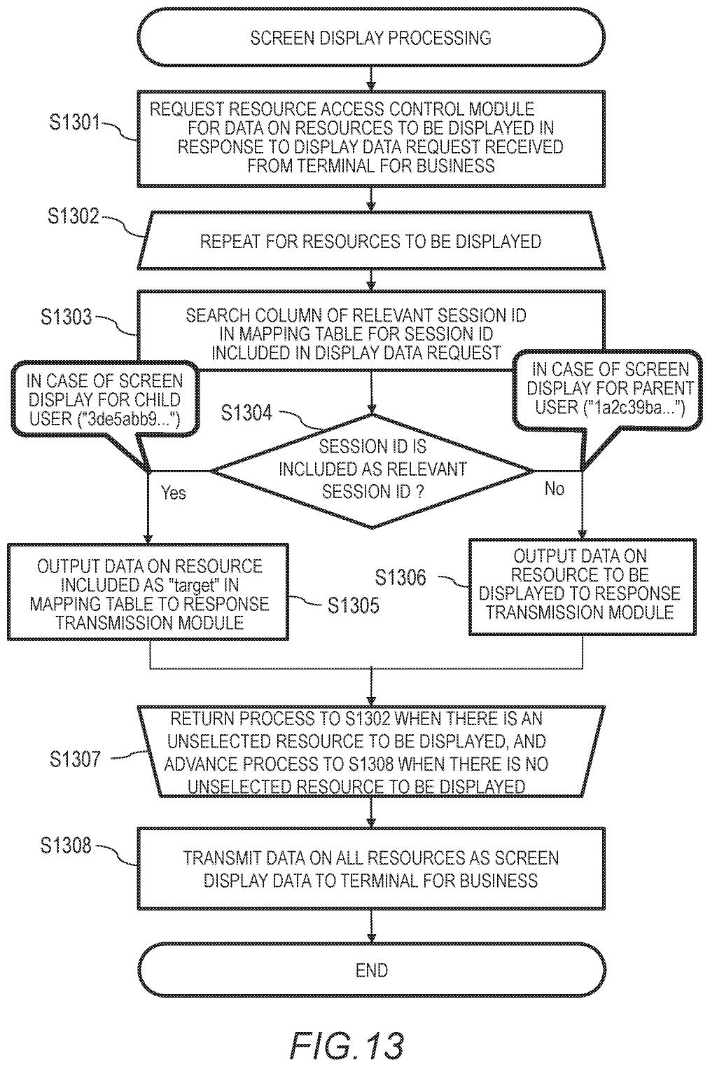

FIG. 13 is a flow chart for illustrating an example of the screen display processing. The concealment apparatus 102 causes the request reception module 151 to receive a display data request from the terminal 103 for business, and requests the resource access control module 161 for data on resources to be displayed (Step S1301).

The display data request requires the session ID 501 of a session established between the terminal 103 for business and the concealment apparatus 102. The display data request is transmitted to the concealment apparatus 102 with an operation of the user on the terminal 103 for business being used as a trigger. In another case, the display data request may be repeatedly transmitted from the terminal 103 for business to the concealment apparatus 102 at regular time intervals.

The resources to be displayed refer to, for example, the values of the ID 702 to the zip code 705 in entries designated to be displayed among the values of the ID 702 to the zip code 705 in all the entries of the resource table 173. Specifically, for example, the resources to be displayed may be the IDs 702 to the zip codes 705 in all the entries of the resource table 173, or may be the IDs 702 to the zip codes 705 in entries corresponding to the display data request received from the terminal 103 for business (for example, entries having the values of the ID 702 designated by the user at discretion).

Subsequently, the concealment apparatus 102 causes the resource access control module 161 to select an unselected resource to be displayed from among the resources to be displayed (Step S1302), and executes processing steps of from Step S1303 to Step S1306 for the selected resource to be displayed. Then, the concealment apparatus 102 causes the resource access control module 161 to determine whether or not there is an unselected resource to be displayed. The concealment apparatus 102 returns the process to Step S1302 when there is an unselected resource to be displayed, and advances the process to Step S1308 when there is no unselected resource to be displayed (Step S1307).

In Step S1303, the concealment apparatus 102 causes the resource access control module 161 to search the column of the relevant session ID 803 in the mapping table 174 for the value of the session ID 501 included in the display data request (Step S1303).

A case in which a value matching the session ID 501 included in the display data request is included as the relevant session ID 803 (“Yes” in Step S1304) is a case in which the session ID 501 included in the display data request is the session ID 501 of a child session. In other words, the display data request received from the terminal 103 for business that has used a child session for login includes the relevant session ID 803. Therefore, the concealment apparatus 102 causes the resource access control module 161 to acquire the target 802 (combination of the values of the resource type 601 and the UUID 701 of the dummy data 202) in the entry having the relevant session ID 803 matching the session ID 501 included in the display data request.

Then, the concealment apparatus 102 causes the resource access control module 161 to acquire the data (values of the ID 702 to the zip code 705) in the entry having the UUID 701 of the dummy data 202 from the resource table 173 regarding the resource type 601 of the dummy data 202. Then, the concealment apparatus 102 outputs the acquired data to the response transmission module 152 (Step S1305), and advances the process to Step S1307.

Meanwhile, a case in which the value matching the session ID 501 included in the display data request is not included as the relevant session ID 803 (“No” in Step S1304) is a case in which the session ID 501 included in the display data request is the session ID 501 of a parent session. In other words, the display data request received from the terminal 103A for business for which the parent session has been generated does not include the relevant session ID 803. Therefore, the concealment apparatus 102 causes the resource access control module 161 to acquire the values of ID 702 to the zip code 705 in the entry of the resource to be displayed selected in Step S1302 from the resource table 173 as the data on the resource to be displayed.

Then, the concealment apparatus 102 outputs the acquired data to the response transmission module 152 (Step S1306), and advances the process to Step S1307.

When there is no unselected resource to be displayed in Step S1307, the concealment apparatus 102 causes the response transmission module 152 to transmit the data acquired in Step S1305 and Step S1306 as screen display data to the terminal 103 for business that has output the display data request (Step S1308). The concealment apparatus 102 thereafter ends the screen display processing.

With this screen display processing, for example, the customer information is displayed on the Web screen 130A of the terminal 103A for business as illustrated in FIG. 2 (with the name of “Luffy”), and the customer information is displayed on the Web screen 130B of the terminal 103B for business as illustrated in FIG. 2 (with the name of “Strawhat”).

<Data Update Processing>

Next, data update processing is described. The data update processing is processing in which, in response to a change of data performed on the terminal 103 for business, the concealment apparatus 102 updates the data and reflects the data on the Web screen 130 of another terminal 103 for business as illustrated in FIG. 3 and FIG. 4.

Referring to FIG. 3 as an example, as a premise of the data update processing, the customer information of the master data 201 is displayed as the data on the resource on the Web screen 130A of the terminal 103A for business, and the customer information of the dummy data 202 is displayed as the data on the resource on the Web screen 130B of the terminal 103B for business.

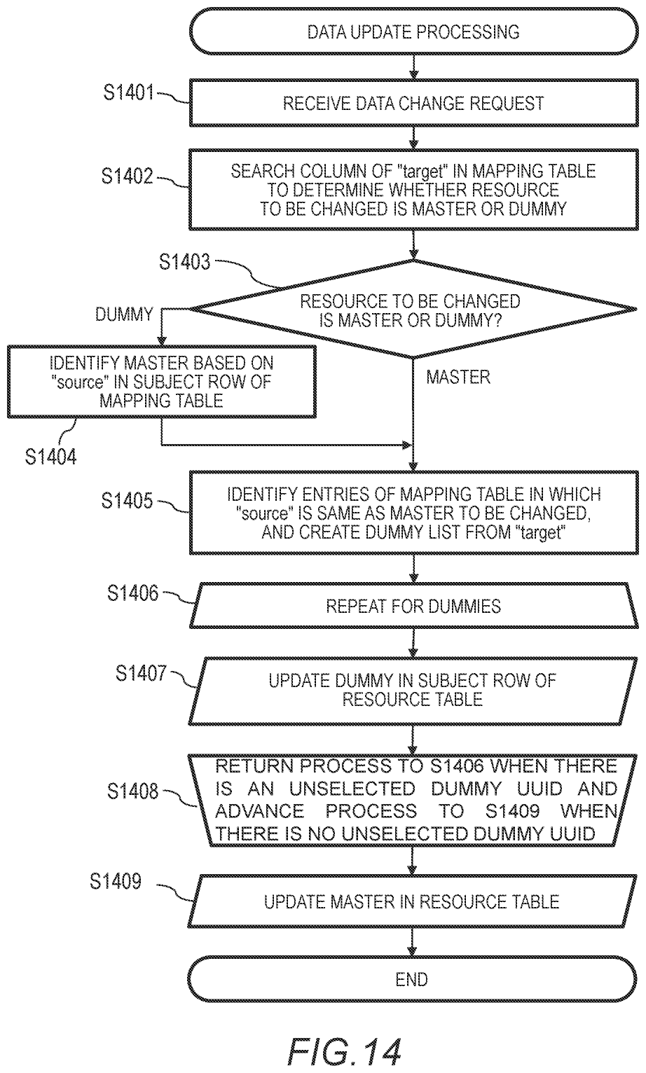

FIG. 14 is a flow chart for illustrating an example of the data update processing. First, the concealment apparatus 102 receives a data change request from the Web screen 130 of the terminal 103 for business (Step S1401). Specifically, for example, as illustrated in FIG. 3, when the rank is changed from “Silver” to “Gold” on the Web screen 130B of the terminal 103B for business by the operation of the user UB, the concealment apparatus 102 causes the request reception module 151 to receive a change request for the dummy data 202.

The data change request requires: a resource to be changed, which is displayed on the Web screen 130 as the customer information; a parameter to be changed; and a value after the change. In the above-mentioned example, the resource to be changed is the customer information of the dummy data 202 displayed on the Web screen 130B. Specifically, for example, the resource to be changed is the entry of the resource table 173 shown in FIG. 7 with the UUID 701 being “0x0A01,” the ID 702 being “0x01,” the rank 703 being “Silver,” the name 704 being “Strawhat,” and the zip code 705 being “000-00.” The parameter to be changed is the rank 703 operated by the user UB. The value after the change is the character string of “Gold” changed from “Silver” by the user UB.

Subsequently, the concealment apparatus 102 causes the resource access control module 161 to search the column of the target 802 in the mapping table 174 for the UUID 701 of the resource to be changed, and to determine whether the resource to be changed is the master data 201 or the dummy data 202 based on a result of the search (Step S1402). Specifically, for example, when the value of the UUID 701 included in the resource to be changed is not included in the target 802, the resource to be changed is the master data 201, and when the value is included in the target 802, the resource to be changed is the dummy data 202.

In the above-mentioned example, “0x0A01” being the UUID 701 of the resource to be changed is included in the target 802 in the entry in the first row of the mapping table 174, and hence the resource to be changed is the dummy data 202.

Subsequently, when the resource access control module 161 determines that the resource to be changed is the master data 201 (“MASTER” in Step S1403), the concealment apparatus 102 advances the process to Step S1405. Meanwhile, when the resource access control module 161 determines that the resource to be changed is the dummy data 202 (“DUMMY” in Step S1403), the concealment apparatus 102 identifies the UUID 701 of the master data 201 based on the source 801 in the entry in which the value of the UUID 701 of the resource to be changed is included in the target 802 (Step S1404), and advances the process to Step S1405. In the above-mentioned example, “0x0001” is identified as the UUID 701 of the master data 201.

In Step S1405, the concealment apparatus 102 causes the resource access control module 161 to identify entries of the mapping table 174 in which the source 801 has the value of the UUID 701 of the master data 201 identified in Step S1402 or Step S1404, and to identify the UUIDs 701 of pieces of dummy data 202 based on the targets 802 in the identified entries, to thereby create a list of the UUIDs 701 of the pieces of dummy data 202 (hereinafter referred to as “dummy list”) (Step S1405).

In the above-mentioned example, the UUID 701 of the master data 201 is “0x0001,” and hence the value of “0x0A01” of the target 802 in the entry having the value of the source 801 being “0x0001” is added to the dummy list. When the mapping table 174 further includes a value of the target 802 in the entry having the value of the source 801 being “0x0001,” the value is also added to the dummy list. The UUID 701 in the dummy list is referred to as “dummy UUID 701.”

Subsequently, the concealment apparatus 102 causes the data updating module 163 to select an unselected dummy UUID 701 from the dummy list (Step S1406).

Subsequently, the concealment apparatus 102 causes the data updating module 163 to identify the entry including the value of the selected dummy UUID 701 in the resource table 173 as the dummy data 202, and to update the value of the parameter to be changed to the value after the change in the identified entry (Step S1407), and advances the process to Step S1408.

In the above-mentioned example, the entry having the value of the dummy UUID 701 being “0x0A01” is identified in the resource table 173. The parameter to be changed in the data change request is the rank 703, and hence the value of “Silver” of the rank 703 in the identified entry is updated to “Gold” being the value after the change in the data change request.

Subsequently, the concealment apparatus 102 causes the data updating module 163 to determine whether or not there is an unselected dummy UUID 701 in the dummy list. When there is an unselected dummy UUID 701, the concealment apparatus 102 returns the process to Step S1406, and otherwise advances the process to Step S1409 (Step S1408).

Subsequently, the concealment apparatus 102 causes the data updating module 163 to identify the entry having the value of the UUID 701 of the master data 201 identified in Step S1402 or Step S1404 in the resource table 173, and to update the value of the parameter to be changed to the value after the change in the identified entry (Step S1409). After that, the image display processing illustrated in FIG. 12 is performed to display the data updated in Step S1407 and Step S1409 on the Web screen 130 of the terminal 103 for business that has not transmitted the data change request, and the data update processing is ended.

In the above-mentioned example, in response to the data update performed in Step S1409, the value of “Rank” is changed from “Silver” to “Gold” on the Web screen 130A of the terminal 103A for business as illustrated in FIG. 3.

<Session Discard Processing>

Next, session discard processing is described. The session discard processing refers to processing in which the concealment apparatus 102 discards a session.

FIG. 15 is a flow chart for illustrating an example of the session discard processing. First, the concealment apparatus 102 receives a session discard instruction (Step S1501). When a logout button is pressed on the terminal 103 for business by an operation of the user, the session discard instruction is transmitted from the terminal 103 for business to the concealment apparatus 102, and is received by the request reception module 151. In another case, when a preset expiration time for a session has elapsed since the establishment of the session inside the concealment apparatus 102, the resource access control module 161 receives the session discard instruction. The session discard instruction includes the session ID 501 (hereinafter referred to as “session-to-be-discarded ID 501”) of a session that is to be discarded (hereinafter referred to as “session to be discarded”).

Subsequently, the concealment apparatus 102 causes the resource access control module 161 to retrieve the entry in which the session-to-be-discarded ID 501 is the parent session ID 504 from the session table 171 (Step S1502).

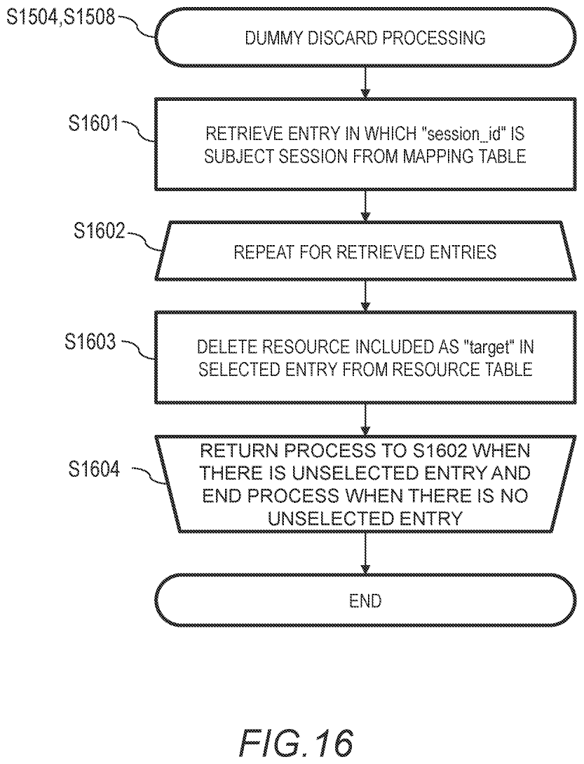

When the session-to-be-discarded ID 501 is not registered as the parent session ID 504 in the retrieved entry (“No” in Step S1503), the session-to-be-discarded ID 501 is registered only as the session ID 501. Therefore, the session to be discarded is a child session. In this case, the concealment apparatus 102 causes the data updating module 163 to execute dummy discard processing for the child session being the session to be discarded (Step S1504). The dummy discard processing (Step S1504) is described later with reference to FIG. 16.

Then, the concealment apparatus 102 causes the data updating module 163 to delete the entry for the session to be discarded (child session) from the session table 171 (Step S1505).

Meanwhile, when the session-to-be-discarded ID 501 is registered as the parent session ID 504 in the retrieved entry in Step S1503 (“Yes” in Step S1503), the session to be discarded is a parent session. Therefore, the concealment apparatus 102 causes the resource access control module 161 to refer to the parent session ID 504 in the retrieved entry to collect child session IDs for the session to be discarded, which is the parent session, to thereby create a child session list (Step S1506).

Subsequently, the concealment apparatus 102 causes the data updating module 163 to select an unselected child session ID (Step S1507), and to execute dummy discard processing for the selected child session ID (Step S1508). The dummy discard processing performed in Step S1508 is the same processing as the dummy discard processing performed in Step S1504, and is described later with reference to FIG. 16. Then, the concealment apparatus 102 causes the data updating module 163 to delete the entry for the selected child session ID from the session table 171 (Step S1509).

After that, the concealment apparatus 102 causes the data updating module 163 to determine whether or not there is an unselected child session ID in the child session list. When there is an unselected child session ID, the concealment apparatus 102 returns the process to Step S1507, and otherwise advances the process to Step S1511 (Step S1510).

Then, the concealment apparatus 102 causes the data updating module 163 to delete the entry for the session to be discarded (parent session) from the session table 171 (Step S1511). The concealment apparatus 102 thereafter ends the session discard processing.

<Dummy Discard Processing>

FIG. 16 is a flow chart for illustrating an example of the dummy discard processing (each of Step S1504 and Step S1508) illustrated in FIG. 15. The concealment apparatus 102 causes the resource access control module 161 to retrieve the entry in which the relevant session ID 803 is a session ID of interest (session ID of the child session in Step S1504 or session ID of the parent session in Step S1508) from the mapping table 174 (Step S1601).

Subsequently, the concealment apparatus 102 causes the data updating module 163 to select an unselected entry from among the entries retrieved from the mapping table 174 (Step S1602).

Then, the concealment apparatus 102 causes the data updating module 163 to delete the entry of the resource identified by the UUID 701 included in the target 802 in the selected entry from the resource table 173 (Step S1603). In addition, although not shown, the concealment apparatus 102 may cause the data updating module 163 to delete the entry selected in Step S1602 from the mapping table 174.

After that, the concealment apparatus 102 causes the data updating module 163 to determine whether or not there is an unselected entry. When there is an unselected entry, the concealment apparatus 102 returns the process to Step S1602, and otherwise ends the dummy discard processing (each of Step S1504 and Step S1508) (Step S1604).

As described above, according to the at least one embodiment, it is determined based on the user name 502 and the parameter 602 which parameter 602 has data that is required to be concealed from the user of the user name 502 and which parameter 602 has data that is not required to be concealed from the user.

Specifically, for example, data is more likely to be concealed from a user as the first concealment control level 503 of the user becomes lower, and data is also more likely to be concealed as the data has the value of the parameter 602 corresponding to the higher second concealment control level 604. Further, data changed on the Web screen 130 is reflected on the Web screen 130 of another terminal 103 for business in real time.

Therefore, among a plurality of users having different first concealment control levels 503, an intended resource can be simultaneously displayed on the Web screens 130 as the master data 201 for one user and the dummy data 202 for another user.

Accordingly, it is possible to achieve simultaneous work between users having different first concealment control levels 503. In addition, costly and stressful workloads such as collecting/editing of screenshots and construction of a simulated environment are reduced.

It should be noted that this disclosure is not limited to the above-mentioned embodiments, and encompasses various modification examples and the equivalent configurations within the scope of the appended claims without departing from the gist of this disclosure. For example, the above-mentioned embodiments are described in detail for a better understanding of this disclosure, and this disclosure is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. A concealment apparatus, comprising:
a processor configured to execute a program; and
a storage device configured to store the program,
the processor being configured to execute:
concealment processing for controlling, in regard to a resource having one or more items and data indicating details of the one or more items, concealment of the data based on an attribute of a user and attributes of the one or more items for each user; and
first output processing for outputting the resource which is based on a concealment result of executing the concealment processing for each user, to a terminal corresponding to the each user.

2. The concealment apparatus according to claim 1, wherein the processor is configured to execute the first output processing to output the resource having the data that is not concealed, to the terminal when the attribute of the user is a first user attribute indicating that the data is not required to be protected.

3. The concealment apparatus according to claim 1, wherein the processor is configured to execute the first output processing to output the resource which is based on the concealment result for the data relating to the attributes of the one or more items, to the terminal when the attribute of the user is not a first user attribute indicating that the data is not required to be protected.

4. The concealment apparatus according to claim 3, wherein the processor is configured to execute the first output processing to output the resource having the data that is not concealed, to the terminal when each of the attributes of the one or more items is a first item attribute indicating that the data is not required to be protected.

5. The concealment apparatus according to claim 3, wherein the processor is configured to execute the first output processing to output the resource which is based on the concealment result for the data relating to the attribute of the user and the attributes of the one or more items, to the terminal when each of the attributes of the one or more items is not a first item attribute indicating that the data is not required to be protected.

6. The concealment apparatus according to claim 5, wherein the processor is configured to execute the first output processing to output the resource having the data that is concealed, to the terminal when the attribute of the user is a second user attribute indicating that the data is required to be protected.

7. The concealment apparatus according to claim 5, wherein the processor is configured to execute the first output processing to output the resource having the data that is concealed, to the terminal when each of the attributes of the one or more items is a second item attribute indicating that the data is required to be protected.

8. The concealment apparatus according to claim 5, wherein the processor is configured to execute the first output processing to output the resource having the data that is not concealed, to the terminal when the attribute of the user is not a second user attribute indicating that the data is required to be protected and each of the attributes of the one or more items is not a second item attribute indicating that the data is required to be protected.

9. The concealment apparatus according to claim 2, wherein the processor is configured to:
execute generation processing for generating, when a session has been established between the terminal of the user having the first user attribute and the concealment apparatus, a child session relating to the session, between the terminal of another user that does not have the first user attribute and the concealment apparatus; and
execute the first output processing to output the resource as a first resource to the terminal of the user having the first user attribute and to output, as a second resource, the resource which is based on a concealment result of executing the concealment processing, to the terminal of the another user for which the child session has been generated.

10. The concealment apparatus according to claim 9, wherein the processor is configured to execute the first output processing to output, when the attribute of the another user is a second user attribute indicating that the data is required to be protected, the resource to the terminal of the another user by: avoiding concealing the data for which one of the attributes of the one or more items is a first item attribute indicating that the data is not required to be protected; and concealing the data for which one of the attributes of the one or more items is not the first item attribute.

11. The concealment apparatus according to claim 9, wherein the processor is configured to execute the first output processing to output, when the attribute of the another user is a user attribute other than both the first user attribute and a second user attribute indicating that the data is required to be protected, the resource to the terminal of the another user by: avoiding concealing the data for which one of the attributes of the one or more items is a first item attribute indicating that the data is not required to be protected; concealing the data for which one of the attributes of the one or more items is a second item attribute indicating that the data is required to be protected; and concealing the data for which one of the attributes of the one or more items is an item attribute other than both the first item attribute and the second item attribute.

12. The concealment apparatus according to claim 9, wherein the processor is configured to execute:
update processing for updating, when the data has been changed on the terminal of the another user, the first resource and the second resource based on an item to be changed, which corresponds to the data that has been changed, and data after the change; and
second output processing for outputting the first resource that has been updated in the update processing, to the terminal of the user having the first user attribute.

13. The concealment apparatus according to claim 9, wherein the processor is configured to execute:
update processing for updating, when the data has been changed on the terminal of the user having the first user attribute, the first resource and the second resource based on an item to be changed, which corresponds to the data that has been changed, and data after the change; and
second output processing for outputting the second resource that has been updated in the update processing, to the terminal of the another user.

14. A concealment method to be executed by a concealment apparatus,
the concealment apparatus including:
a processor configured to execute a program; and
a storage device configured to store the program, the concealment method comprising executing, by the processor:
concealment processing for controlling, in regard to a resource having one or more items and data indicating details of the one or more items, concealment of the data based on an attribute of a user and attributes of the one or more items for each user; and
first output processing for outputting the resource which is based on a concealment result of executing the concealment processing for each user, to a terminal corresponding to the each user.

15. A computer-readable non-transitory recording medium having recorded thereon a concealment program for causing a processor to execute:
concealment processing for controlling, in regard to a resource having one or more items and data indicating details of the one or more items, concealment of the data based on an attribute of a user and attributes of the one or more items for each user; and
first output processing for outputting the resource which is based on a concealment result of executing the concealment processing for each user, to a terminal corresponding to the each user.
